(19) United States
(12) Patent Application Publication
(10) Pub. No.: US 2025/0178056 A1
(43) Pub. Date: Jun. 5, 2025

(54) SAFE DEPOSIT BOX HOUSING AND INTEGRATED FORMING PROCESS THEREFOR

(71) Applicant: Ningbo TigerKing Safe Co., Ltd., Ningbo (CN)

(72) Inventor: Junbiao CHEN, Ningbo (CN)

(73) Assignee: Ningbo TigerKing Safe Co., Ltd., Ningbo, ZJ (CN)

(21) Appl. No.: 18/431,981

(22) Filed: Feb. 4, 2024

(30) Foreign Application Priority Data
Nov. 30, 2023 (CN) 202311629360.3

(51) Int. Cl. B21C 23/14; B65D 1/26; B65D 1/40

(52) U.S. Cl. CPC B21C 23/14; B65D 1/26; B65D 1/40

(57) ABSTRACT

The invention belongs to the technical field of safe deposit boxes, and relates to a safe deposit box housing and an integrated forming method therefor. The integrated forming process comprises the following steps: blanking; drawing; shaping, trimming and shearing to obtain a housing blank; forming a groove in a front end plate of the housing blank by means of a door frame forming die, and forming an outer door frame by a part, other than the groove, of the front end plate; enabling an edge of the rest of the groove to extend towards a back surface in a direction perpendicular to the back surface by means of a door frame flanging die to form the flange, other than the flange, of the rest of the groove; and shaping the flange to obtain a safe deposit box housing.

### BACKGROUND OF THE INVENTION

### 1. Technical Field

The invention belongs to the technical field of safe deposit boxes, and relates to a safe deposit box housing and an integrated forming method therefor.

### 2. Description of Related Art

The safe deposit box, as a security product, is mainly used for storing valuables. In the existing safe deposit box industry, although there is a great demand for safe deposit boxes, the price of the safe deposit boxes is generally extremely low. In order to reduce the cost and improve the market competitiveness of products, thin steel sheets (within 2 mm) are often used as materials for manufacturing boxes during traditional safe deposit box production. The production process mainly comprises: a, machining a housing (comprising a top plate, left and right side plates and a bottom plate) and a back plate respectively through a step of blanking and a step of bending; b, machining a housing (comprising a top plate and left and right side plates), a bottom plate and a back plate respectively through a step of blanking and a step of bending; or, c, machining a housing (comprising a top plate and left and right side plates), a bottom-back plate and other parts respectively through a step of blanking and a step of bending, and then making a safe deposit box by welding and polishing. In the step of bending adopted by the traditional production process, there is a certain deviation between the actual bending angle and the theoretically calculated value or the design requirement (bending deviation) and bending limitations exist no matter which type of equipment is used; and in the step of welding, deformation of parts will be caused due to heat input. All these drawbacks lead to a simple and monotonous appearance of existing safe deposit boxes, a slow production schedule, and serious quality defects. Due to the difficulty in manufacturing and machining, the integrated forming process for housings has not yet been used in the safe deposit box industry so far.

### BRIEF SUMMARY OF THE INVENTION

In view of the drawbacks in the prior art, the invention provides a safe deposit box housing and an integrated forming process thereof.

One objective of the invention is fulfilled through the following technical solution:

A safe deposit box housing is formed integrally and comprises:
a side frame configured to be of an enclosed ring shape and comprising atop plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame connected to one side of the side frame and provided with a first through-groove connected with the receiving cavity, wherein a groove wall of the first through-groove extends in an axial direction of the first through-groove to form a first extended edge; and
an inner door frame connected to the first extended edge and provided with a second through-groove connected with the first through-groove and the receiving cavity, wherein a groove wall of the second through-groove extends in an axial direction of the second through-groove to form a flange;
wherein, the safe deposit box housing is manufactured from cold-rolled steel sheets of a deep drawing grade and above through an integrated forming process.

Preferably, the side frame is shaped like a hollow cuboid.

Preferably, embossed structures are arranged on a surface of any one or more of the left side plate, the right side plate, the bottom plate and the top plate of the side frame.

Preferably, embossed structures are arranged on surfaces of the left side plate, the right side plate and the top plate.

The cold-rolled steel sheets of the deep drawing grade and above are integrally formed to manufacture the safe deposit box housing directly without a step of welding. The cold-rolled steel sheets of the deep drawing grade and above may be cold-rolled steel sheets of the deep drawing grade, cold-rolled steel sheets of a super-deep drawing grade, cold-rolled steel sheets of an extra-deep drawing grade, or cold-rolled steel sheets of a super-extra deep drawing grade.

Preferably, the cold-rolled steel sheets of the deep drawing grade and above have a thickness less than or equal to 2 mm, further preferably 0.7-1.5 mm.

Preferably, the cold-rolled steel sheets of the deep drawing grade and above with the thickness of 0.7-1.5 mm have the following properties: the yield strength Rp0.2 is 100-220 MPa, the tensible strength Rm is 250-350 MPa, and the percentage of elongation A80 is over 39%.

Optionally, the cold-rolled steel sheets of the deep drawing grade and above may be DC04, DC05, DC06, DC07 or DC08 in accordance with the European standard DIN EN 10130, or ST14, ST15, ST16 or ST17 in accordance with the German Standard DIN1623-1, or SPCE, SPCG or SPCEN in accordance with the Japanese Standard JIS G3141. Preferably, the cold-rolled steel sheets of the deep drawing grade and above is ST16 or DC06.

Preferably, the integrated forming process comprises the following steps:
blanking: using the cold-rolled steel sheets of the deep drawing grade and above as raw materials, and cutting the cold-rolled steel sheets to obtain steel sheets of required dimensions;
drawing: stamping and drawing the steel sheets to form a drawn product, wherein the drawn product comprises a left side plate, a right side plate, a bottom plate, a top plate and a front end plate, the top plate, the bottom plate, the left side plate, the right side plate and the front end plate define a receiving cavity, and a back surface of the drawn product is open;
shaping, trimming and shearing: shaping the drawn product by means of a shaping die; trimming redundant steel sheet scrap on edges of the drawn product by means of a trimming die; shearing off a drawing margin of the drawn product by means of a shearing die to obtain a housing blank;
outer door frame molding: forming a groove in the front end plate of the housing blank by means of a door frame forming die, and forming an outer door frame by a part, other than the groove, of the front end plate, wherein the outer door frame is connected with the groove through a first extended edge;
frame cutting: removing part of the groove by means of a frame cutting die, wherein the rest of the groove (the rest of the groove refers to a groove part that is not removed) is used for forming an inner door frame and a flange;
door frame flanging: enabling an edge of the rest of the groove to extend towards the back surface in a direction perpendicular to the back surface by means of a door frame flanging die to form the flange, and forming the inner door frame by a part, other than the flange, of the rest of the groove; and
shaping the flange to obtain the safe deposit box housing.

An extension length of the first extended edge is a depth of the outer door frame, and an extension length of the flange is a depth of the flange or the inner door frame.

A second objective of the invention is fulfilled through the following technical solution:

An integrated forming process for a safe deposit box housing comprises the following steps:
blanking: using cold-rolled steel sheets of a deep drawing grade and above as raw materials, and cutting the cold-rolled steel sheets to obtain steel sheets of required dimensions;
drawing: stamping and drawing the steel sheets to form a drawn product, wherein the drawn product comprises a left side plate, a right side plate, a bottom plate, a top plate and a front end plate, the top plate, the bottom plate, the left side plate, the right side plate and the front end plate define a receiving cavity, and a back surface of the drawn product is open;
shaping, trimming and shearing: shaping the drawn product by means of a shaping die; trimming redundant steel sheet scrap on edges of the drawn product by means of a trimming die; shearing off a drawing margin of the drawn product by means of a shearing die to obtain a housing blank;
outer door frame molding: forming a groove in the front end plate of the housing blank by means of a door frame forming die, and forming an outer door frame by a part, other than the groove, of the front end plate;
frame cutting: removing part of the groove by means of a frame cutting die, wherein the rest of the groove (the rest of the groove refers to a groove part that is not removed) is used for forming an inner door frame and a flange;
door frame flanging: enabling an edge of the rest of the groove to extend towards the back surface in a direction perpendicular to the back surface by means of a door frame flanging die to form the flange, and forming the inner door frame by a part, other than the flange, of the rest of the groove; and
shaping the flange to obtain the safe deposit box housing.

In the step of blanking, the cold-rolled steel sheets of the deep drawing grade and above may be cold-rolled steel sheets of the deep drawing grade, cold-rolled steel sheets of a super-deep drawing grade, cold-rolled steel sheets of an extra-deep drawing grade, or cold-rolled steel sheets of a super-extra deep drawing grade.

The cold-rolled steel sheets of the deep drawing grade and above have a thickness less than or equal to 2 mm, further preferably 0.7-1.5 mm.

Preferably, the cold-rolled steel sheets of the deep drawing grade and above with the thickness of 0.7-1.5 mm have the following properties: the yield strength Rp0.2 is 100-220 MPa, the tensible strength Rm is 250-350 MPa, and the percentage of elongation A80 is over 39%.

Optionally, the cold-rolled steel sheets of the deep drawing grade and above may be DC04, DC05, DC06, DC07 or DC08 in accordance with the European standard DIN EN 10130, or ST14, ST15, ST16 or ST17 in accordance with the German Standard DIN1623-1, or SPCE, SPCG or SPCEN in accordance with the Japanese Standard JIS G3141. Preferably, the cold-rolled steel sheets of the deep drawing grade and above is ST16 or DC06.

In the step of drawing, preferably, the drawn product is shaped like a hollow cuboid. Preferably, the front end plate of the drawn product is square or rectangular. The depth of the drawn product should be greater than that of the safe deposit box housing, and a depth difference between the drawn product and the safe deposit box housing is referred to as a drawing margin. Here, the depth refers to the distance from the front surface and the back surface. The redundant drawing margin is beneficial to subsequent shaping. The drawing margin is 2-15% of the depth of the safe deposit box housing.

In the step of shaping, the drawn product can be shaped multiple times to improve the dimensional accuracy of the product.

In the step of outer door frame molding, preferably, the groove is formed with a central point of the front end plate as a center, and a central point of the groove is the centra point of the front end plate.

Preferably, the groove is rectangular, square, triangular, trapezoidal, circular, oval, regular pentagonal or regular hexagonal.

Preferably, the groove is formed with the central point of the front end plate as the center, the central point of the groove is the central point of the front end plate, and the groove is rectangular or square. In this way, four edges of the front end plate are parallel to corresponding four edges of the groove respectively.

In the step of frame cutting, preferably, part of the groove is removed with a central point of the groove as a center.

In a case where the groove is rectangular or square, part of the groove is removed with the central point of the rectangular or square groove as the center, and the removed part of the groove is rectangular or square.

In the step of door frame flanging, the formed flange is approximately shaped like a hollow cuboid with a front surface and a back surface being open, and the ratio of the depth of the flange to the depth of the outer door frame is 0.2-1.5:1.

Preferably, the integrated forming process further comprises a step of embossing, which comprises: forming multiple embossed structures on the surface of one or more of the left side plate, the right side plate, the bottom plate and the top plate of the housing blank by means of an embossing die.

The step of embossing is performed between the step of shearing and the step of outer door frame molding, or after the step of flanging shaping. The specific sequence of the step of embossing is determined according to the relative positions of the embossed structures and the flange. If the minimum horizontal distance between the embossed structures and the flange is greater than the minimum distance between the edge of the embossing die and the embossed structures, the step of embossing can be performed between the step of shearing and the step of outer door frame molding, and can also be performed after the step of flange shaping. If the minimum horizontal distance between the embossed structures and the flange is less than or equal to the minimum distance between the edge of the embossing die and the embossed structures, the step of embossing should be performed between the step of shearing and the step of outer door frame molding.

Preferably, multiple embossed structures are formed on the surfaces of the left side plate, the right side plate and the top plate respectively by means of the embossing die.

The embossed structures on the surfaces of the plates may be identical or different, and the embossed structures on the surface of the same plate may be identical or different. Each embossed structure is independent. The embossed structures protrude with respect to outer surfaces of the plates. The planar shape of each embossed structure may be any shape, including one or more of an S shape, a sawtooth shape, an oval shape, a star shape, a circular shape and a polygonal shape (such as a quadrangular shape, a pentagonal shape, a hexagonal shape or octagonal shape).

For the drawn product formed by thin steel sheets, the embossed structures not only can improve the aesthetics of the appearance of the product, but also can improve the strength of the product (the embossed structures are equivalent to reinforcing ribs embossed on steel sheets).

Preferably, a safe deposit box housing manufactured through the integrated forming process comprises:
a side frame configured to be of an enclosed ring shape and comprising atop plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame connected to one side of the side frame and provided with a first through-groove connected with the receiving cavity, wherein a groove wall of the first through-groove extends in an axial direction of the first through-groove to form a first extended edge; and
an inner door frame connected to the first extended edge and provided with a second through-groove connected with the first through-groove and the receiving cavity, wherein a groove wall of the second through-groove extends in an axial direction of the second through-groove to form a flange.

Preferably, the side frame is shaped like a hollow cuboid.

An extension length of the first extended edge is a depth of the outer door frame, and an extension length of the flange is a depth of the flange or the inner door frame.

Compared with the prior art, the invention has the following beneficial effects:
1. The safe deposit box housing provided by the invention is manufactured through an integrated forming process, thus avoiding quality defects of existing housings manufactured through bending and welding and having better quality;
2. The integrated forming process provided by the invention greatly improves production efficiency and reduces costs, thus bringing greater benefits for enterprises;
3. The safe deposit box housing manufactured through the integrated forming process has higher strength;
4. A safe deposit box with a more aesthetic appearance and a more complex shape can be obtained.

### BRIEF DESCRIPTION OF THE SEVERAL VIEWS OF THE DRAWINGS

FIG. 1 illustrates a three-dimensional view of a safe deposit box housing according to one embodiment of the invention;

FIG. 2 illustrates a three-dimensional view of a safe deposit box housing according to another embodiment of the invention;

FIG. 3 is a sectional view of FIG. 2;

FIG. 4 illustrates views of a drawn product obtained in a step of drawing in Embodiment 1, wherein the view on the left is a front view of the drawn product, and the view on the right is a sectional view along A-A in the front view on the left;

FIG. 5 illustrates views of a trimmed product obtained in a step of drawing in Embodiment 1, wherein the view on the left is a front view of the trimmed product, and the view on the right is a sectional view along A-A in the front view on the left;

FIG. 6 illustrates views of a housing blank obtained in a step of shearing in Embodiment 1, wherein the view on the left is a front view of the housing blank, and the view on the right is a sectional view along A-A in the front view on the left;

FIG. 7 illustrates views of an embossed product obtained in a step of embossing in Embodiment 1, wherein the view on the left is a front view of the embossed product, and the view on the right is a sectional view along A-A in the front view on the left;

FIG. 8 illustrates views of a product obtained in a step of outer door frame molding in Embodiment 1, wherein the view on the left is a front view of the product, and the view on the right is a sectional view along A-A in the front view on the left;

FIG. 9 illustrates views of a product obtained by frame cutting in a step of frame cutting in Embodiment 1, wherein the view on the left is a front view of the product, and the view on the right is a sectional view along A-A in the front view on the left;

FIG. 10 illustrates views of a housing product obtained in a step of door frame flanging in Embodiment 1, wherein the view on the left is a front view of the housing product, and the view on the right is a sectional view along A-A in the front view on the left;

FIG. 11 is a three-dimensional view of a safe deposit box housing manufactured in Comparative Example 1.

### DETAILED DESCRIPTION OF THE INVENTION

The invention will be described more clearly and completely below in conjunction with embodiments and accompanying drawings, but the invention is not limited to the following embodiments.

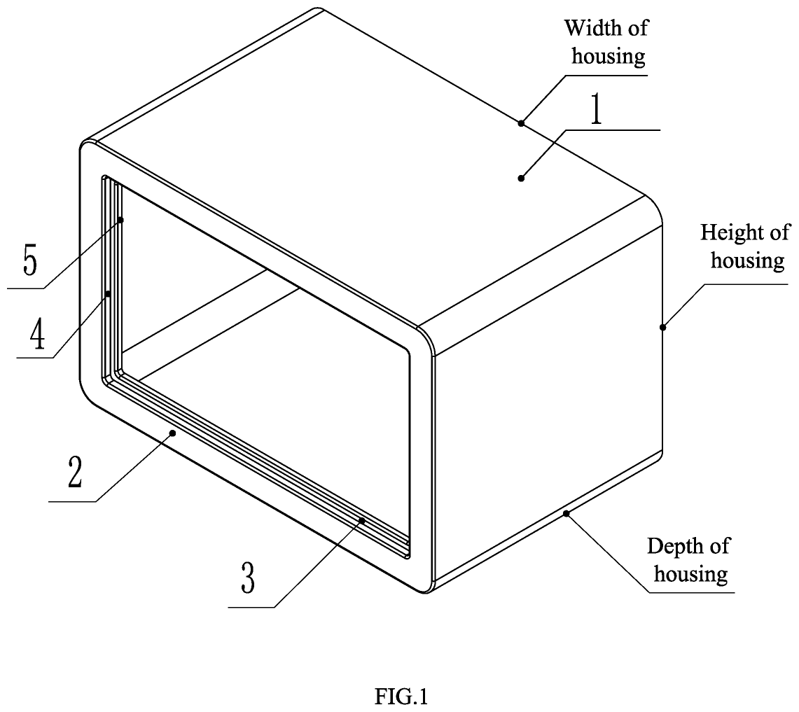

FIG. 1 illustrates a three-dimensional view of a safe deposit box housing according to one embodiment of the invention. As shown in FIG. 1, the safe deposit box housing is formed integrally and comprises:
a side frame 1 configured to be of an enclosed ring shape and comprising a top plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame 2 connected to one side of the side frame 1 and provided with a first through-groove connected with the receiving cavity, wherein a groove wall of the first through-groove extends in an axial direction of the first through-groove to form a first extended edge 4; and
an inner door frame 3 connected to the first extended edge 4 and provided with a second through-groove connected with the first through-groove and the receiving cavity, wherein a groove wall of the second through-groove extends in an axial direction of the second through-groove to form a flange 5.

The left side plate and the right side plate of the side frame form a left surface and a right surface of the housing respectively, the top plate and the bottom plate of the side frame form a top surface and a bottom surface of the housing respectively, the height of the housing refers to the distance from the upper surface of the housing to the bottom surface of the housing, the width of the housing refers to the distance from the left surface of the housing to the right surface of the housing, and the depth of the housing refers to the distance from a front surface of the housing to a back surface of the housing.

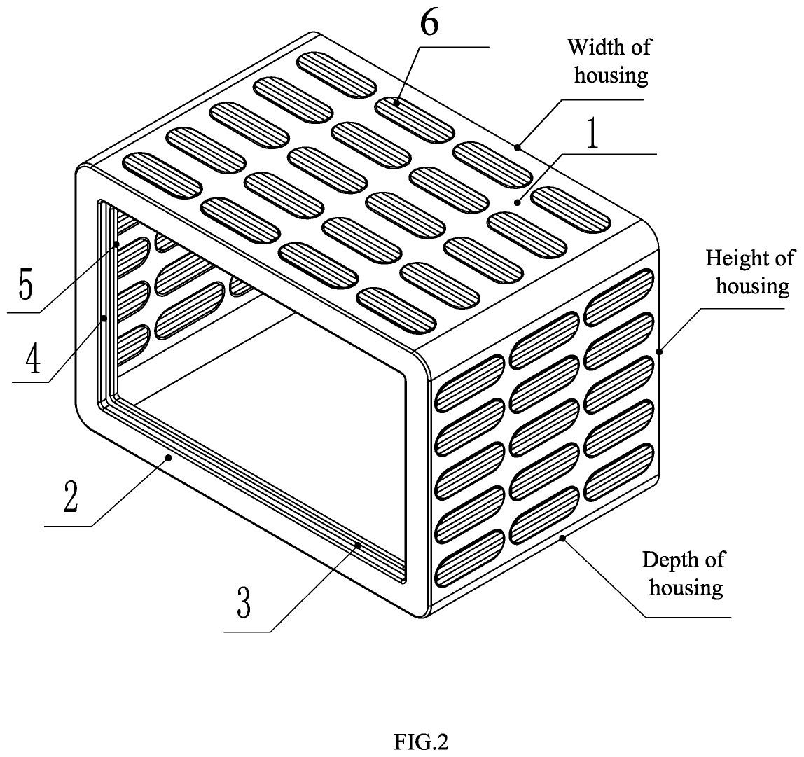

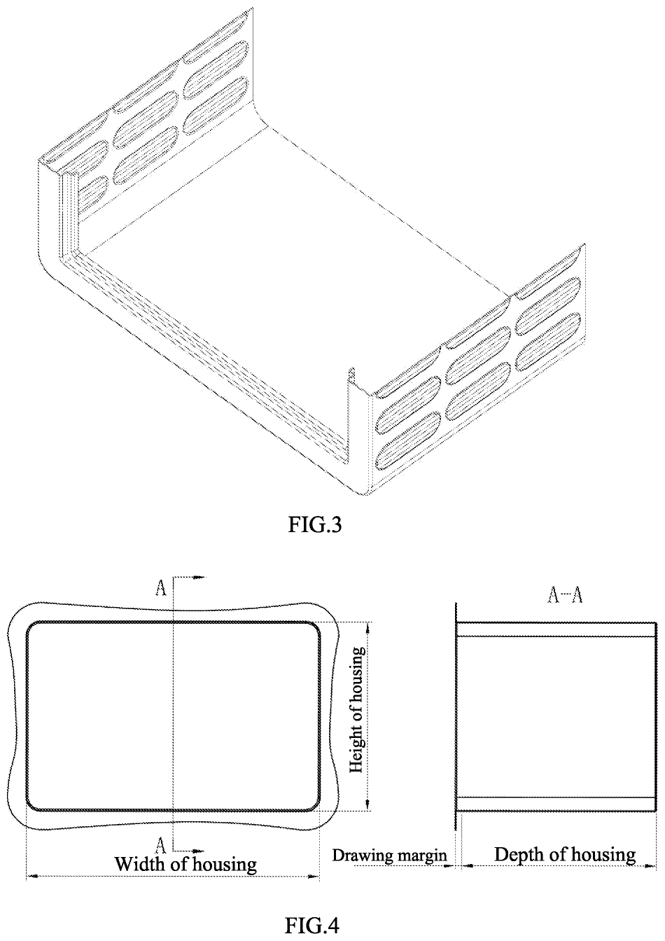

FIG. 2 and FIG. 3 illustrate a safe deposit box housing according to another embodiment of the invention. As shown in FIG. 2 and FIG. 3, the safe deposit box housing is formed integrally and comprises:
a side frame 1 configured to be of an enclosed ring shape and comprising a top plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame 2 connected to one side of the side frame 1 and provided with a first through-groove connected with the receiving cavity, wherein a groove wall of the first through-groove extends in an axial direction of the first through-groove to form a first extended edge 4;
an inner door frame 3 connected to the first extended edge 4 and provided with a second through-groove connected with the first through-groove and the receiving cavity, wherein a groove wall of the second through-groove extends in an axial direction of the second through-groove to form a flange 5;
embossed structures 6, wherein the embossed structures 6 are arranged on the surface of any one or more of the left side plate, the right side plate, the bottom plate and the top plate. In FIG. 2, the embossed structures 6 are arranged on the surfaces of the left side plate, the right side plate and the top plate.

The technical solutions of the invention will be further described below in conjunction with specific embodiments and drawings. It should be understood that the specific embodiments in the following description are used for helping understand the invention, and are not used for limiting the invention. The drawings in the specification are merely for better describing the contents disclosed by the invention, and are not intended to limit the protection scope of the invention. Unless otherwise especially stated, raw materials used in the embodiments of the invention are all common raw materials in the art, and the methods adopted in the embodiments of the invention are all conventional methods in the art.

### Embodiment 1

An integrated forming process for a safe deposit box housing comprises the following steps:

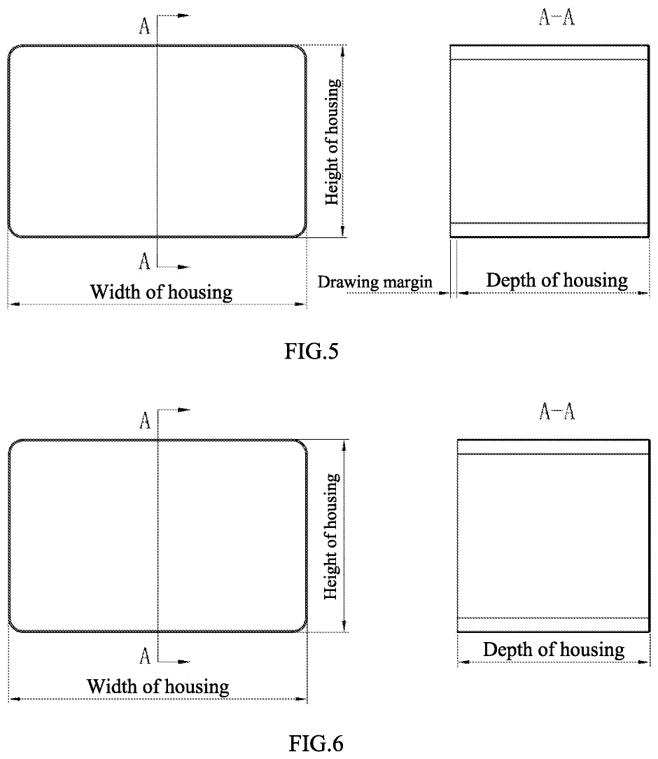

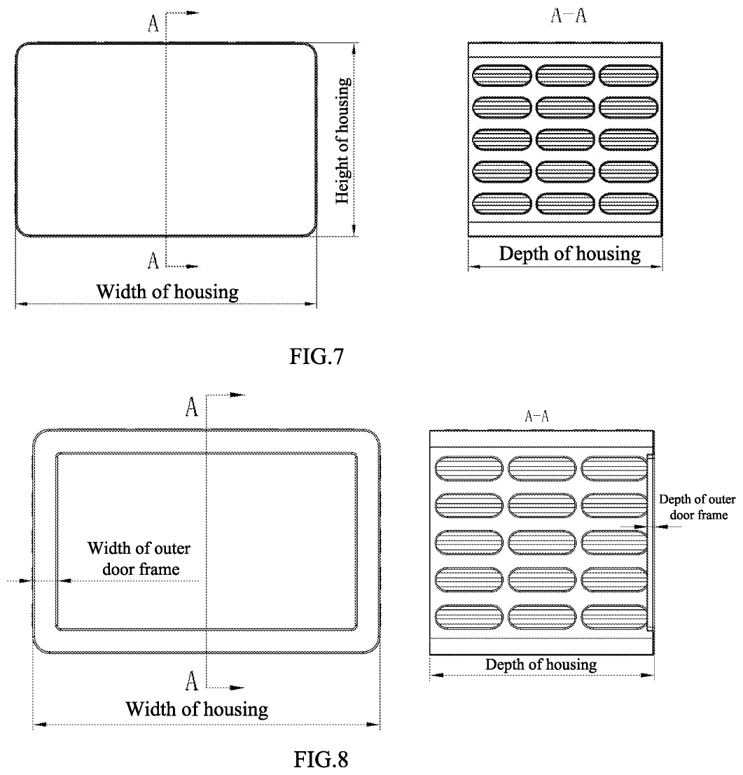

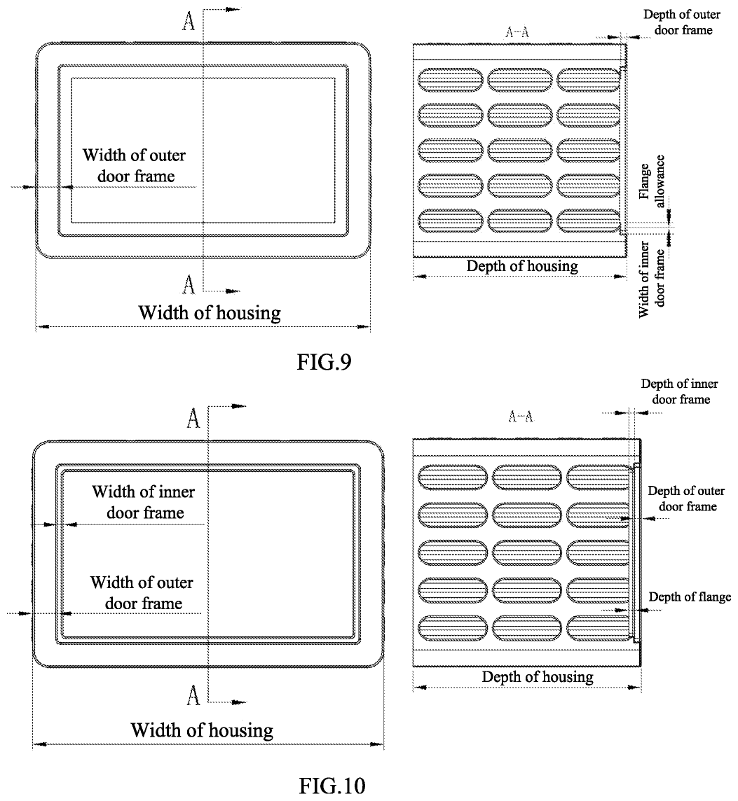

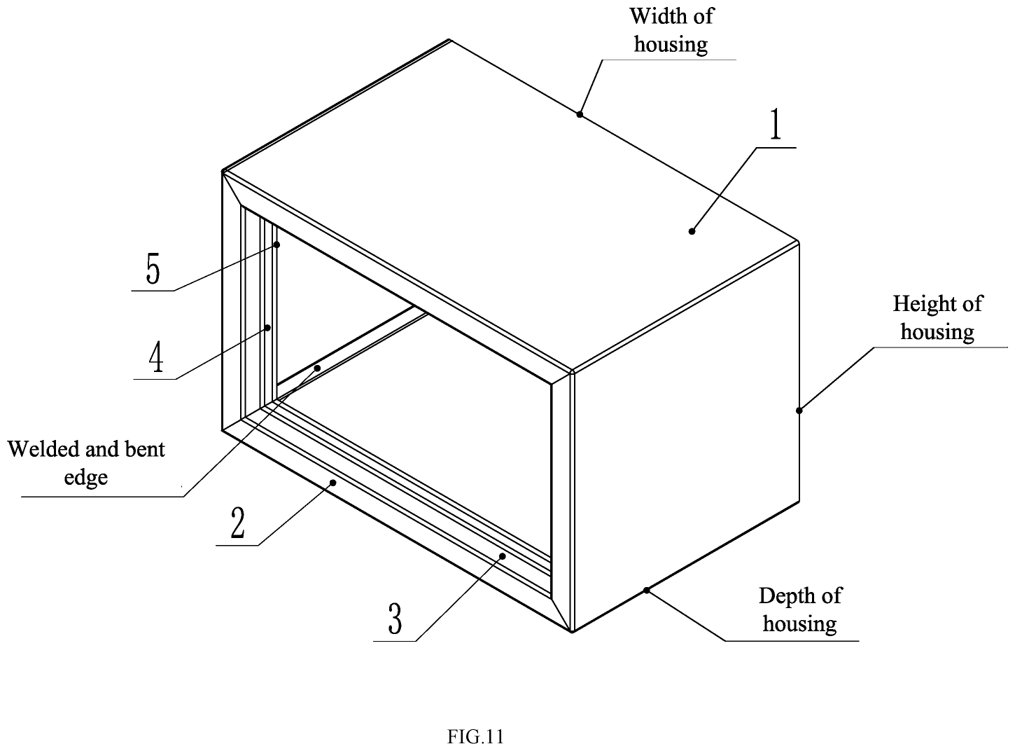

Blanking: using extra-deep drawing steel sheets ST16 with a thickness of 0.8 mm as raw materials, and cutting the extra-deep drawing steel sheets ST16 into rectangular steel sheets with a width of 600 mm and a length of 650 mm by means of a laser cutting machine;
drawing: placing the rectangular steel sheets in a hydraulic machine (model: YQ32-100; nominal force: 1000KN), and punching and drawing the rectangular steel sheets according to the shape of an upper die and a lower side of the hydraulic machine to form a drawn product shaped like a hollow cuboid, wherein the drawn product has a width of 310 mm, a height of 200 mm and a depth of 215 mm, and comprises a left side plate, a right side plate, a bottom plate, a top plate and a front end plate, the front end plate is rectangular, the top plate, the bottom plate, the left side plate, the right side plate and the front end plate define a receiving cavity, a back surface of the drawn product is open, a front view and section view of the drawn product are shown in FIG. 4 (the view on the left is the front view, and the view on the right is the sectional view along A-A in the front view on the left), at this moment, the depth (215 mm) of the drawn product is greater than the depth (200 mm) of an actual safe deposit box housing, and the depth difference is referred to as a drawing margin (15 mm), which is beneficial for subsequent shaping;
shaping: shaping the drawn product twice by means of a shaping die to make corners of the drawn product smoother, planes of the drawn product flatter and straighter, and the shape of the drawn product satisfy designed appearance and dimensional requirements;
trimming: trimming redundant steel plate scrap on edges of the drawn product by means of a trimming die to obtain a trimmed product, as shown in FIG. 5;
shearing: after trimming, removing the drawing margin of the drawn product by means of a shearing die to obtain a housing blank, as shown in FIG. 6, wherein the width, height and depth of the product obtained after shearing are consistent with those of the actual housing;
embossing: forming multiple embossed structures, that are arranged in sequence, on the surface of the top plate, the surface of the left side plate and the surface of the right side plate of the housing blank respectively by means of an embossing die, as shown in FIG. 7, wherein each embossed structure is independent, the planar shape of each embossed structure is oval, and the embossed structures protrude with respect to outer surfaces of the plates;
outer door frame molding: with a central point of the front end plate as a center, forming a rectangular groove in the front end plate of the embossed product by means of a door frame forming die, and forming an outer door frame by a part, other than the groove, of the front end plate, as shown in FIG. 8, wherein the outer door frame has a width of 22 mm and a depth of 6 mm;
frame cutting: with a central point of the rectangular groove as a center, removing part of the groove by means of a frame cutting die, wherein the removed part of the groove is a rectangular, and the rest of the groove (a groove part that is not removed) is used for forming an inner door frame and a flange, and the product obtained after frame cutting is shown in FIG. 9;
door frame flanging: enabling an edge of the rest of the groove to extend towards the back surface in a direction perpendicular to the back surface by means of a door frame flanging die to form the flange, and forming the inner door frame by a part, other than the flange, of the rest of the groove to obtain a product, as shown in FIG. 10, wherein the formed flange is approximately shaped like a hollow cuboid with a front surface and a back surface being open, the depth of the flange, which is also the depth of the inner door frame, is 5 mm, and the width of the inner door frame is 5 mm; and
shaping the flange to obtain a safe deposit box housing.

The structure of the safe deposit box housing manufactured through the integrated forming process in Embodiment 1 is shown in FIG. 2. The safe deposit box housing has a width of 310 mm, a height of 200 mm and a depth of 200 mm.

### Embodiment 2

An integrated forming process for a safe deposit box housing comprises the following steps:

Embodiment 2 is different from Embodiment 1 merely in that the step of embossing is omitted in Embodiment 2 and the step of outer door frame molding is performed directly after the step of shearing. Other steps in Embodiment 2 are the same as those in Embodiment 1.

The structure of the safe deposit box housing manufactured through the integrated forming process in Embodiment 2 is shown in FIG. 1.

### Comparative Example 1

In Comparative example 1, a safe deposit box housing is manufactured using existing bending and welding processes through the following steps:
blanking: using steel sheets Q235 with a thickness of 0.9 mm as raw materials, and cutting the steel sheets Q235 into rectangular steel sheets with a width of 244.5 mm and a length of 1023 mm by means of a laser cutting machine;
bending: bending the rectangular steel sheets nine times according to a metal plate forming drawing to form a top plate, left and right side plates, a bottom plate, a corresponding inner door frame and a corresponding outer door frame; and
welding: fully welding seams formed in the step of bending to finally form a housing shown in FIG. 11.

Comparative example 1 is different from Embodiment 1 mainly in the following aspects: metal plates are bent and welded to form the housing in Comparative example 1, and embossing is not available in Comparative example 1; in Embodiment 1, steel sheets are drawn on the whole and embossing is performed to improve the strength of parts and the aesthetics of the appearance of the housing.

A strength destructive test is carried out on the safe deposit box housing manufactured in Embodiment 1 and the safe deposit box housing formed through conventional bending and welding in Comparative example 1:

Equipment adopted is a hydraulic machine (model: YQ32-100; nominal force: 1000 KN), and strength destructive test is carried out on the safe deposit box housing manufactured in Embodiment 1 and the safe deposit box housing formed through conventional bending and welding in Comparative example 1, under the condition of same equipment and place; when the box deforms completely (pressing of a whole surface rather than partial destruction), the larger the reading of the pressure gauge of the hydraulic machine, the higher the strength of the tested product.

Test result: a, the maximum pressure required for deformation of the safe deposit box housing manufactured in Embodiment 1 is about 3 MPa; b, the maximum pressure required for deformation of the existing safe deposit box housing is about 2.5 MPa.

The above data indicates that the strength of the safe deposit box housing manufactured through the integrated forming process provided by the invention is significantly improved, as compared with the existing safe deposit box housing manufactured through bending and welding.

All aspects, embodiments and features of the invention should be construed as descriptive rather than restrictive, and the scope of the invention is defined only by the claims. Without departing from the spirit and scope of the invention, those skilled in the art can obtain other embodiments, amendments and uses.

The sequence of the steps of the integrated forming method provided by the invention is not limited to the sequences listed. Variations of the sequence of the steps made by those ordinarily skilled in the art without creative labor should also fall within the protection scope of the invention. In addition, two or more steps or actions may be performed at the same time.

Finally, it should be noted that the specific embodiments described in the specification are merely used for describing the invention by way of examples, and are not limitations of the implementations of the invention. Those skilled in the art can make various amendments, supplements or similar equivalents to the specific embodiments described above, and it is unnecessary and impossible to list all possible embodiments here. These obvious transformations or variations obtained based on the essential spirit of the invention should still fall within the protection scope of the invention, and it is contrary to the spirit of the invention to interpreting these transformations or variations as any additional limitation.

What is claimed is:

1. A safe deposit box housing, wherein the safe deposit box housing is formed integrally and comprises:
a side frame configured to be of an enclosed ring shape and comprising a top plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame connected to one side of the side frame and provided with a first through-groove connected with the receiving cavity, wherein a groove wall of the first through-groove extends in an axial direction of the first through-groove to form a first extended edge; and
an inner door frame connected to the first extended edge and provided with a second through-groove connected with the first through-groove and the receiving cavity, wherein a groove wall of the second through-groove extends in an axial direction of the second through-groove to form a flange;
wherein, the safe deposit box housing is manufactured from cold-rolled steel sheets of a deep drawing grade and above through an integrated forming process.

2. The safe deposit box housing according to claim 1, wherein the side frame is shaped like a hollow cuboid.

3. The safe deposit box housing according to claim 1, wherein embossed structures are arranged on a surface of any one or more of the left side plate, the right side plate, the bottom plate and the top plate of the side frame.

4. The safe deposit box housing according to claim 1, wherein the cold-rolled steel sheets of the deep drawing grade and above have a thickness less than or equal to 2 mm.

5. The safe deposit box housing according to claim 1, wherein the cold-rolled steel sheets of the deep drawing grade and above have a thickness of 0.7-1.5 mm.

6. The safe deposit box housing according to claim 5, wherein the cold-rolled steel sheets of the deep drawing grade and above with the thickness of 0.7-1.5 mm have the following properties: the yield strength Rp0.2 is 100-220 MPa, the tensible strength Rm is 250-350 MPa, and the percentage of elongation A80 is over 39%.

7. The safe deposit box housing according to claim 1, wherein the integrated forming process comprises the following steps:
blanking: using the cold-rolled steel sheets of the deep drawing grade and above as raw materials, and cutting the cold-rolled steel sheets to obtain steel sheets of required dimensions;
drawing: stamping and drawing the steel sheets to form a drawn product, wherein the drawn product comprises a left side plate, a right side plate, a bottom plate, a top plate and a front end plate, the top plate, the bottom plate, the left side plate, the right side plate and the front end plate define a receiving cavity, and a back surface of the drawn product is open;
shaping, trimming and shearing: shaping the drawn product by means of a shaping die; trimming redundant steel sheet scrap on edges of the drawn product by means of a trimming die; shearing off a drawing margin of the drawn product by means of a shearing die to obtain a housing blank;
outer door frame molding: forming a groove in the front end plate of the housing blank by means of a door frame forming die, and forming an outer door frame by a part, other than the groove, of the front end plate, wherein the outer door frame is connected with the groove through a first extended edge;
frame cutting: removing part of the groove by means of a frame cutting die, wherein the rest of the groove (the rest of the groove refers to a groove part that is not removed) is used for forming an inner door frame and a flange;
door frame flanging: enabling an edge of the rest of the groove to extend towards the back surface in a direction perpendicular to the back surface by means of a door frame flanging die to form the flange, and forming the inner door frame by a part, other than the flange, of the rest of the groove; and
shaping the flange to obtain the safe deposit box housing.

8. An integrated forming process for a safe deposit box housing, comprising the following steps:
blanking: using cold-rolled steel sheets of a deep drawing grade and above as raw materials, and cutting the cold-rolled steel sheets to obtain steel sheets of required dimensions;
drawing: stamping and drawing the steel sheets to form a drawn product, wherein the drawn product comprises a left side plate, a right side plate, a bottom plate, a top plate and a front end plate, the top plate, the bottom plate, the left side plate, the right side plate and the front end plate define a receiving cavity, and a back surface of the drawn product is open;
shaping, trimming and shearing: shaping the drawn product by means of a shaping die; trimming redundant steel sheet scrap on edges of the drawn product by means of a trimming die; shearing off a drawing margin of the drawn product by means of a shearing die to obtain a housing blank;
outer door frame molding: forming a groove in the front end plate of the housing blank by means of a door frame forming die, and forming an outer door frame by a part, other than the groove, of the front end plate;
frame cutting: removing part of the groove by means of a frame cutting die, wherein the rest of the groove is used for forming an inner door frame and a flange;
door frame flanging: enabling an edge of the rest of the groove to extend towards the back surface in a direction perpendicular to the back surface by means of a door frame flanging die to form the flange, and forming the inner door frame by a part, other than the flange, of the rest of the groove; and
shaping the flange to obtain the safe deposit box housing.

9. The integrated forming process according to claim 8, wherein the cold-rolled steel sheets of the deep drawing grade and above have a thickness of 0.7-1.5 mm.

10. The integrated forming process according to claim 9, wherein the cold-rolled steel sheets of the deep drawing grade and above with the thickness of 0.7-1.5 mm have the following properties: the yield strength Rp0.2 is 100-220 MPa, the tensible strength Rm is 250-350 MPa, and the percentage of elongation A80 is over 39%.

11. The integrated forming process according to claim 8, wherein the drawn product obtained in the step of drawing is shaped like a hollow cuboid.

12. The integrated forming process according to claim 8, wherein in the step of outer door frame molding, the groove is formed with a central point of the front end plate as a center, and a central point of the groove is the centra point of the front end plate.

13. The integrated forming process according to claim 12, wherein the groove is rectangular or square.

14. The integrated forming process according to claim 8, wherein in the step of frame cutting, part of the groove is removed with a central point of the groove as a center.

15. The integrated forming process according to claim 14, wherein in a case where the groove is rectangular or square, part of the groove is removed with the central point of the rectangular or square groove as the center, and the removed part of the groove is rectangular or square.

16. The integrated forming process according to claim 8, wherein the integrated forming process further comprises a step of embossing, which comprises: forming multiple embossed structures on a surface of one or more of the left side plate, the right side plate, the bottom plate and the top plate of the housing blank by means of an embossing die;
the step of embossing is performed between the step of shearing and the step of outer door frame molding, or after the step of flanging shaping.

17. The integrated forming process according to claim 16, wherein multiple embossed structures are formed on surfaces of the left side plate, the right side plate and the top plate respectively by means of the embossing die.

18. The integrated forming process according to claim 8, wherein a safe deposit box housing manufactured through the integrated forming process comprises:
a side frame configured to be of an enclosed ring shape and comprising a top plate and a bottom plate which are located on upper and lower sides, and a left side plate and a right side plate which are located on left and right sides, wherein the top plate, the bottom plate, the left side plate and the right side plate define a receiving cavity with a receiving function;
an outer door frame connected to one side of the side frame and provided with a first through-groove connected with the receiving cavity, wherein a groove wall of the first through-groove extends in an axial direction of the first through-groove to form a first extended edge; and
an inner door frame connected to the first extended edge and provided with a second through-groove connected with the first through-groove and the receiving cavity, wherein a groove wall of the second through-groove extends in an axial direction of the second through-groove to form a flange.

19. The integrated forming process according to claim 8, wherein the side frame is shaped like a hollow cuboid.
